(19) United States
(12) Patent Application Publication
(10) Pub. No.: US 2002/0167954 A1
(43) Pub. Date: Nov. 14, 2002

(54) Point-to-multipoint access network integrated with a backbone network

(75) Inventors: William R. Highsmith, Indialantic, FL (US); John R. Wood, Danbury (GB)

Correspondence Address: RICHARD K. WARTHER, Allen, Dyer, Doppelt, Milbrath & Gilchrist, P.A., 255 S. Orange Avenue, Suite 1401, P.O. Box 3791, Orlando, FL, 32802, US

(73) Assignee: P-COM, Inc., Campbell, CA

(21) Appl. No.: 10/142,267

(22) Filed: May 9, 2002

Related U.S. Application Data
(60) Provisional application No. 60/290,257, filed on May 11, 2001.

(51) Int. Cl. H04L 12/28; H04Q 7/00

(52) U.S. Cl. 370/406; 370/400; 370/328

(57) ABSTRACT

A communication system includes a plurality of network nodes and communication links that link the network nodes to form a high bandwidth backbone network. At least one of the communication links forms a point-to-multipoint communications link between two network nodes. At least one of the network nodes has a point-to-multipoint remote device at one end the point-to-multipoint communications link. At least one of the network nodes has a point-to-multipoint sector transceiver at the other end of the communications link for transmitting in a sectored point-to-multipoint downstream communications link with remote devices, including the linked point-to-multipoint remote device at the network node and receiving data from the point-to-multipoint remote device at the network node in a point-to-multipoint upstream communications link.

### RELATED APPLICATION

This application is based upon prior filed copending provisional application Ser. No. 60/290,257 filed May 11, 2001.

### FIELD OF THE INVENTION

The present invention relates to the field of communication networks, and more specifically, the present invention relates to backbone communications networks and point-to-multipoint access networks.

### BACKGROUND OF THE INVENTION

Communication networks frequently use a backbone network having a ring, hierarchical, mesh or other circuit topology to carry heavy user traffic to strategic points (backbone network nodes) in the area of service coverage. As is well known to those skilled in the art, the backbone network, consisting of various nodes connected by communication links, typically connects to public or private networks. From these backbone network nodes, the network provides an access network to the backbone network for nearby users. For example, along an optical fiber backbone network, the network designer may place optical fiber or radio spurs (point-to-point links) from backbone nodes to the user sites. These spurs form the access service network, in this one example. Backbone networks may also be constructed from other transmission media, including terrestrial radio, fiberless optical links, and satellite links. The access network may be constructed from the same or different media types as used in the backbone network, in any combination, such as an optical fiber backbone network with optical and/or terrestrial radio spurs.

One technology used for access networking is the use of point-to-multipoint radio. Point-to-multipoint networks have a base station or other transmitter/receiver pair or transceiver that communicates with a plurality of remote terminals or devices (remotes). The base station typically concentrates, such as by multiplexing, user traffic from the remotes onto a ring backbone network or a backhaul circuit to a backbone network. In the reverse direction, the base station demultiplexes and transmits data from the ring or backhaul to the plurality of remotes.

In some cases, the base station is sectorized, having multiple sectors each with its own sector transceiver(s) to cover a portion of the geographical area around the base station. The total geographical area covered by the base station is, of course, a cell forming a cellular network having multiple, adjacent cells to cover a yet wider area. The base station can be considered the collection of sector transmission equipment in the cell and any common equipment used for the base station, such as switches or multiplexers. The sector could be considered the collection of all transmission equipment associated with the sector transceiver therein.

A VSAT (very small aperture terminal) satellite network, on the other hand, typically has one, non-sectorized base station (or hub) for the entire network, although there may be redundant base stations at geographically diverse locations. Throughout this description, the base stations for non-sectorized, point-to-multipoint networks will also be referred to herein as “sectors,” even though there may be only one sector in such networks.

Another technology used for access networking is fiberless, optical point-to-multipoint networking devices and circuits. Fiberless, optical point-to-multipoint networks use a base station that communicates with a plurality of remotes. The base station typically concentrates user traffic from the remotes onto a ring or other backbone network or a backhaul circuit to a backbone network. The backbone network is typically constructed of point-to-point fiber optical or radio links. In the reverse direction, the base station demultiplexes and transmits data from the backbone ring or backhaul circuit to the plurality of optical remotes.

Frequently, the backbone network and access network use different technologies, such that (1) expensive interworking equipment is required to provide an interface between the backbone network and access networks; (2) higher operating costs accrue because of the additional training and support required for multiple fielded technologies; and (3) separate management systems are required to manage the two networks. This frequently occurs in the case of optical backbone networks, since optical spurs sometimes may be technologically difficult or impossible, or prohibitively expensive in metropolitan networks because of the high cost of metropolitan construction, interference with public roadways and passageways, or local ordinance.

It is evident that there is a need for a backbone network and associated access technologies that are more integrated, thereby providing lower equipment cost, lower construction costs, lower operating costs and improved management.

### SUMMARY OF THE INVENTION

It is therefore an object of the present invention to provide an integrated backbone network and access network that overcomes the disadvantages as noted above.

These and other needs are met by the present invention which provides a communications network and a method for operating a communications network having a plurality of point-to-multipoint base stations, the base stations having one or more sectors, each sector having a plurality of point-to-multipoint remotes. The sectors and remotes support the formation of (1) a backbone network having a backbone network topology, and (2) a point-to-multipoint access network.

The backbone network comprises a set of nodes connected by communications links according to the topology of the backbone network. The backbone network node comprises a point-to-multipoint sector transceiver and a point-to-multipoint remote device and a switch therebetween. The network includes the backbone network nodes and forms a link of the backbone network between two backbone network nodes. Adjacent backbone network links are joined to form a backbone network having a backbone network topology.

In accordance with the present invention, a communication system includes a plurality of network nodes and communication links that link the network nodes to form a high bandwidth backbone network. At least one of the communication links forms a point-to-multipoint communications link between two network nodes. At least one of the network nodes has a point-to-multipoint remote device at one end of the point-to-multipoint communications link. At least one of the network nodes has a point-to-multipoint sector transceiver at the other end of the communications link for transmitting data to the point-to-multipoint remote device at the network node in a sectored point-to-multipoint downstream communications link, and receiving data from the point-to-multipoint remote device in a point-to-multipoint upstream communications link.

In yet another aspect of the present invention, the backbone network can comprise a single-ring network, a double-ring network, a full mesh network, a partial mesh network, a hierarchical network, a grid network, or a concatenated network. The node having the point-to-multipoint sector transceiver can include a plurality of sector transceivers, each operative for covering a respective geographic area. A sector antenna as part of the sector transceiver can wirelessly communicate with remote devices and can be a waveguide antenna, a horn antenna, a smart antenna, a scanning antenna, a beam-shaping antenna, or other antennas known to those skilled in the art.

### BRIEF DESCRIPTION OF THE DRAWINGS

Other objects, features and advantages of the present invention will become apparent from the detailed description of the invention which follows, when considered in light of the accompanying drawings in which:

FIGS. 1A and 1B each illustrate a single-ring network for a backbone network that can be used in the present invention.

FIG. 2 illustrates a double-ring network for a backbone network that can be used in the present invention.

FIG. 3 illustrates a fully-connected mesh network for a backbone network that can be used in the present invention.

FIG. 4 illustrates a partially-connected mesh network that can be used as a backbone network of the present invention.

FIG. 5 illustrates a point-to-multipoint access network which can be used in conjunction with either of the backbone networks shown in FIGS. 1-4 in accordance with the present invention.

FIG. 6 illustrates a backbone network combined with point-to-multipoint access networks (consecutive point-to-multipoint networks) using the topology shown in FIG. 5, in accordance with the present invention.

FIG. 7 illustrates a consecutive point-to-multipoint network as a fixed cellular configuration in accordance with the present invention.

FIG. 8 further illustrates a consecutive point-to-multipoint network having the point-to-multipoint base stations affixed to high-rise buildings in a fixed cellular configuration in accordance with another embodiment of the present invention.

FIG. 9 illustrates a consecutive point-to-multipoint network in a fixed cellular configuration with a base station supporting more than one ring network in accordance with another embodiment of the present invention.

FIG. 10 illustrates a ring network and an appended star network forming a “concatenated” network as a combination of the networks illustrated in FIGS. 1-5.

FIG. 11 illustrates a fiberless, optical point-to-multipoint access network used in conjunction with the backbone network topologies of FIGS. 1-4 in accordance with another embodiment of the present invention.

FIG. 12 illustrates a block diagram for scanning antenna that can control its beam angles and dwell time according to the addressing information contained within user data units.

FIG. 13 illustrates a block diagram for a scanning antenna that can control its beam angles and dwell time according to the addressing information contained within user data units, where a duplex control system is used such that a single beam may be used for transmit and receive.

FIG. 14 is a block diagram illustrating bandwidth-on-demand for consecutive point-to-multipoint downstream links.

FIG. 15 is a block diagram illustrating bandwidth on demand for consecutive point-to-multipoint upstream links.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Communication networks, including backbone networks, are often arranged in a ring architecture, as shown in FIG. 1. In this example, the various nodes 1-4 form a single-ring network, generally indicated by network ring 10, having point-to-point communication links 11 connecting nodes 1-4. In this non-limiting example, network ring 10 has four unidirectional links 11, as indicated by the single direction lines. A physical data unit 14 that is destined, for example, to enter the network via node 1 and exit via node 4, must pass through nodes 2-3 in this example. A physical data unit 14 is a message unit such as a data packet or other means of a type appropriate for transmission over the physical medium being used for the network. In this example, physical data units 14 pass counterclockwise, as indicated by the arrow direction. A physical data unit cannot pass directly between any two of nodes 1-4 that are not adjacent.

Naturally, the network can be designed for a clockwise orientation of a single-ring network. In the case of radio-based ring networks, the communication links are typically formed by radios at each end, each with an antenna illuminating the link. High-gain antennas are typically used to increase the range of the radios and decrease the interference from and to other radio devices. One or two radios, depending on the design, are typically used at each node 1-4 to transmit in one direction and receive from the other direction. Node 1 has an antenna 12 that transmits towards node 2 in the counter-clockwise direction. Node 2 has an antenna 13 for receiving signals from node 1. Although not illustrated in detail, it is possible for a physical data unit 14 to enter the backbone ring 10 from an external user, such as by a switch or multiplexer at each node 1-4. Naturally, the ring is a general term describing the connection architecture as is well known to those skilled in the art, and a non-circular ring network 20 is shown in FIG. 1B.

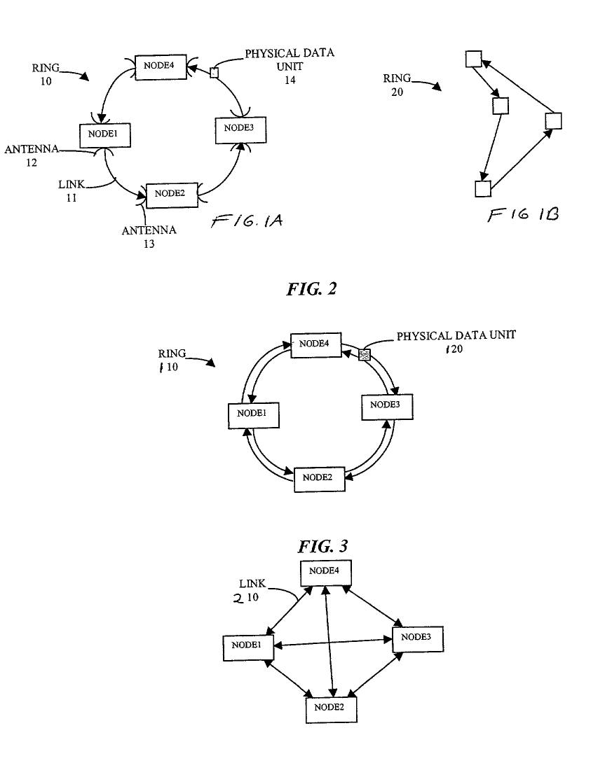

FIG. 2 illustrates a double-ring network 110, where each node 1-4 can transmit physical data units 120 in either direction. Double-ring networks are well-known in the data communications industry and implement redundancy in various ways. In one implementation, if the designated primary ring path fails, all physical data units 120 are sent via the alternate ring path in the opposite direction. In a radio-based double-ring network, as a non-limiting example, typically two radios are used at each node, one to transmit and receive in the clockwise direction, and one to transmit and receive in the counter-clockwise direction.

FIG. 3 illustrates a fully connected mesh network such as constructed from a set of nodes by connecting every node to every other node. For example, nodes 1-4 of FIG. 1 have been rearranged in FIG. 3 as a fully connected mesh network 210, i.e., every node 1-4 in FIG. 3 is connected to every other node at least once. With suitable routing procedures that are well-known in the data communications industry for mesh networks, the network of FIG. 3 may be used as a backbone network.

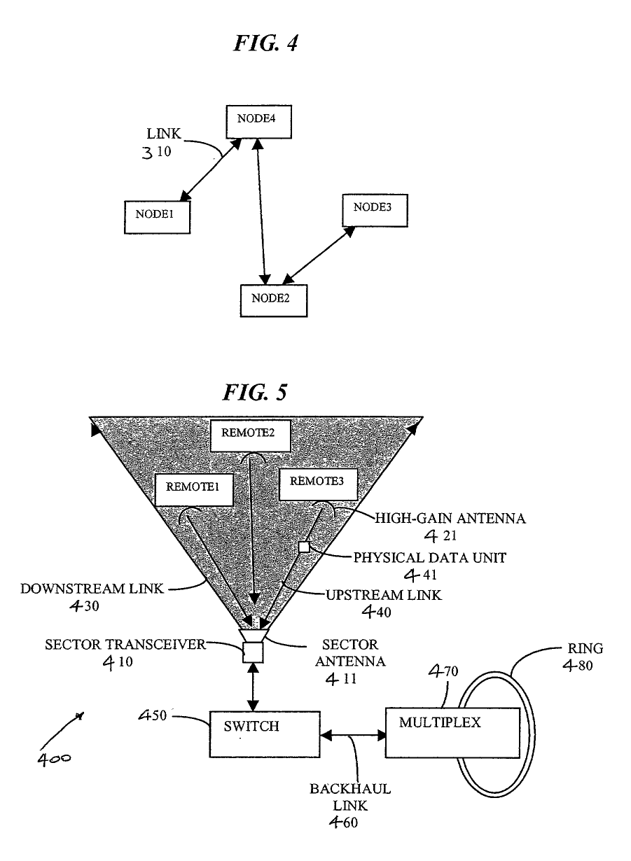

FIG. 4 illustrates another arrangement of nodes 1-4 of FIG. 1 formed into a partially connected mesh network 310, which is not fully connected, but permits navigation from any node to any other node, with suitable routing procedures well-known in the data communications industry for mesh networks. For example, a physical data unit at node 4 travels to node 3 by way of node 2. The network of FIG. 4 is partially connected because some nodes 1-4 are not directly connected to another node 1-4. For example, node 1 is not directly connected to node 2. Throughout this description, the phrase partially connected mesh network is used, and for purposes of illustration, a grid is a partially connected mesh network in which the nodes are placed at all vertices of an n by m matrix, “n” and “m” both being integers greater than one, in which the lines of the matrix are connections between the nodes.

It should be understood that the medium and transmission bandwidth of the ring and mesh networks of FIGS. 1-4 may vary. For example, the list of transmission media includes radio (from 80 meter wavelengths to millimeter wavelengths and above), optical fiber, fiberless optical, and wired. In these networks, the radio technology typically used is a point-to-point terrestrial radio. It would also be possible to construct a satellite network similar to a ring network through consecutive satellite hops. The bandwidth of ring and mesh networks may vary from a few kilobits/second to gigabits/second at standard and non-standard rates.

There are various data communication standards with these associated data rates, such as OC-n standards (n=1, 3, 12, 48, etc.), SDH, STM-n (n=1, 4, 16, etc.), STS-n (n=1, 3, 12, 48, etc.), T-carrier (T1, T3, etc.), E-carrier (E1, E3, etc.), DSn (such as DS3 and DS1), and SONET. There are also various data communications protocols with their associated protocol layers and message unit types, including: ATM, IP, ethernet, token ring, UDP, TCP, frame relay, fast ethernet, X.25, SNA, and ISO OSI. These and other published standards are well-known to those skilled in the art in the data communications industry, and include some national variations. It should also be noted that although some standards may appear to apply only to one medium, they are often used for other media. For example, SONET (Synchronous Optical Network) applies not only to optical networks, but also other media, including radio and electrical (wired) communications media.

Ring, mesh, hierarchical, and other backbone network topologies described herein may be used with these standards and others in various combinations and together with non-standard data rates, protocols, and message types. The descriptions hereafter are non-limiting.

Most data communications devices use standards-based transmission rates and protocols, thus, promoting interworking between products of different vendors, a primary goal of standards as demanded by customers. Many of these standards apply to the interface to the user equipment. For example, an OC-3 radio link will provide a standard OC-3 interface to the user, but may have higher bandwidth over the air to accommodate link management overhead and auxiliary services such as a “wayside T1” channel. Thus, while the over-the-air transmission may vary from a standard, the variances are removed at the interface to the user such that the user perceives a standards-based service. Similarly, such variances may be removed at network-network interfaces, allowing these interfaces to conform to standards. Such variances may also be removed at nodal interfaces, for example, a link in an OC-3 ring may be non-standard in the fiber or over the air, but present a standard interface to the adjacent link.

FIG. 5 illustrates a radio point-to-multipoint network 400 having a sector transceiver 410 through which a plurality of remotes 1-3 communicate. As illustrated, no remote 1-3 can communicate directly with any other remote 1-3. The physical data units 441 from one remote 1-3 may only reach another remote 1-3 if the sector transceiver 410 has an internal or external switch. In the non-limiting illustrated example, sector transceiver 410 is connected to an external switch 450, which is connected via backhaul communications link 460 to a multiplexer 470, which provides an interface to the network ring 480. Alternatively, ring 480 could be connected directly to the sector transceiver 410 if the switch 450 and/or multiplexer 470 are part of the sector transceiver 410 circuitry.

Switching and multiplexing techniques are well-known to those skilled in the art, and various arrangements of switching and multiplexing data units onto ring circuits and other backbone networks are comprehended herein. ATM switches, frame relay switches, ethernet switches, and IP switches/routers are examples of switches 450 that can be used with the present invention. SONET and STM-1 add/drop multiplexers are examples of multiplexers 470 that can be used in the present invention. The multiplexers could be used in combination with an interworking module (not shown), such as an E1 circuit emulation service interworking module, depending on the type of traffic carried on the ring 480. This combination of interworking equipment and add-drop multiplexing equipment is one example of the present invention that interfaces synchronous networks, such as SDH to packet-oriented networks, such as packet-based point-to-multipoint networks. For example, if an STM-1 E1 tributary were carrying a non-packetized voice signal, then the TDM E1 signal could be packetized by an E1 ATM circuit emulation interworking module before connecting to the switch 450.

As is well known, point-to-multipoint networks are commonly used in the industry. One example of a point-to-multipoint network is a VSAT (very small aperture terminal) satellite network. Another example is a terrestrial microwave point-to-multipoint network, such as an LMDS (local multipoint distribution service) network. Also, many fixed and mobile cellular networks include multiple point-to-multipoint networks.

In the illustrated point-to-multipoint configuration of FIG. 5, a single, frequency-division-multiplex (FDM) “downstream” link 430 extends from the sector transceiver 410 to all remotes 1-3. The downstream link 430 is transmitted via sector antenna 411, which covers the area of interest (the sector), often expressed in angular terms, such as a 45 degree or 90 degree sector, as illustrated in the figure as the shaded area. The downstream link 430 as a sector extends outwardly from sector transceiver 410, terminating some distance from sector transceiver 410 to illustrate the practical limit of the range of the radio signal, considering antenna gain, receiver sensitivity, transmit power, weather region, availability requirements, and other considerations commonly used in the radio art.

In addition to frequency division multiplexing, other downstream duplex methods may be used, such as time-division-multiple access (TDMA), spread spectrum, and orthogonal frequency division multiple access (OFDMA). Although only a single downstream carrier is illustrated in FIG. 5, multiple downstream carriers could be used and each remote 1-3 would be attuned only to a designated downstream carrier or carriers.

The upstream link 440 is transmitted via a high-gain antenna 421, in this example, because the upstream link 440 is directed only to a single point, sector transceiver 410, rather than to a plurality of points. Each remote 1-3 has its own upstream link as frequency division multiple access (FDMA). One or more upstream links 440 also may be used with other upstream duplex methods such as TDMA, OFDMA, spread spectrum, and other techniques known to those skilled in the radio art. Some duplexing methods, such as time division duplex (TDD), use a single link for the upstream and downstream direction, switching the direction of transmission between upstream and downstream dynamically based on considerations such as message queuing depth, quality of service, etc.

Point-to-multipoint networks (or sectors) may be co-located with other point-to-multipoint sectors to provide further geographical coverage, and can be connected to switch 450 to provide switching between sectors to backhaul link(s) 460. For example, if 90 degree sector antennas 411 are used, then four sectors could be used to provide 360 degree geographic coverage, providing a ful-coverage cell.

The remote high-gain antennas 421 shown in FIG. 5 are typically formed as parabolic antennas, and sector antennas 411 are typically waveguide antennas, but other antenna types can be used as suggested by those skilled in the art. For example, the high-gain antennas 421 could be scanning or beam-shaping antennas (and other “smart” antennas), flat-panel antennas, cassegrain antennas, or formed of geometries well known to those skilled in the radio art. Sector antennas 411 could also be scanning antennas, beam-shaping antennas (and other “smart” antennas), flat-panel antennas and other antennas geometrically configured well known to those skilled in the radio art. These enumerated antennas are for the microwave radio art, but for lower or higher frequency bands, other antenna technologies would typically be used. For example, in the very high frequency (VHF) bands, yagi antennas could be used as a high-gain antenna 421. Various radio modulation schemes can be used for the upstream link 440 and the downstream link 430, including FSK, PSK, QPSK, 16 QAM, 32 QAM, 64 QAM, and 128 QAM, as non-limiting examples.

Various data communication standards, data rates, protocols, message unit types, duplex methods, antenna types and modulation methods as described can be used in point-to-multipoint networks. Also, access to the backbone network (such as a ring) or to a backhaul is not the only service provided by the point-to-multipoint network. For example, remote-to-remote service within the same sector via the switch 450 is also provided by the point-to-multipoint network. Also, remote-to-remote service between remotes within the same cellular network cell is supported by the point-to-multipoint network.

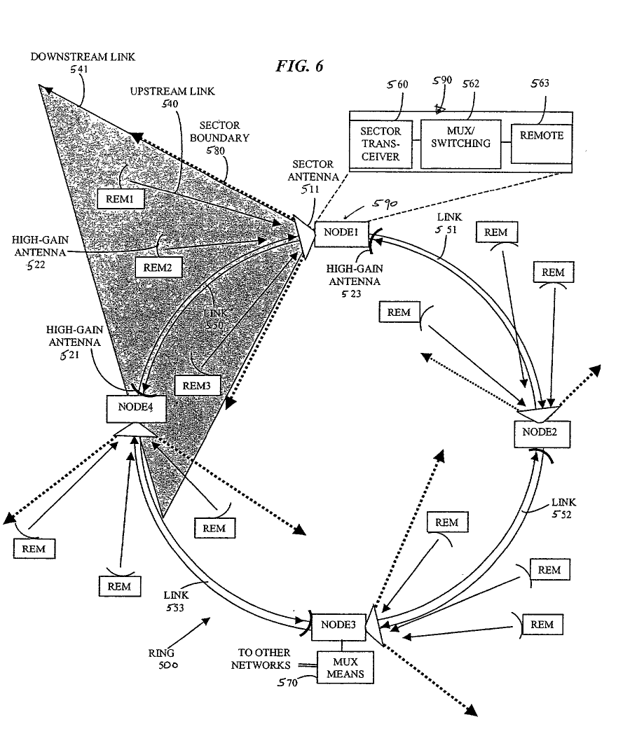

FIG. 6 illustrates a “consecutive point-to-multipoint” (CPMP) network based on a double-ring topology. It is known to those skilled in the art that a ring network can be constructed using point-to-point radios. For example, OC-3 SONET (155 megabit/second) radios with high-gain antennas could be used to provide a SONET ring service to the users. Add-drop multiplexers could provide an interface for customer/user equipment at each ring node.

A novel aspect of the present invention constructs an OC-3 SONET ring and uses point-to-multipoint radios, as shown in FIG. 6, rather than point-to-point radios. In this example, a radio-based, 155 megabit/second (Mb/s) SONET ring 500 comprises nodes 1-4 and links 550-553 with a node indicated generally at 590, and representative of all nodes 1-4. Each node 1-4 includes a point-to-multipoint sector transceiver 560, multiplexer/switch circuit 562, and a point-to-multipoint remote circuit 563. In the illustrated example, node 1 and node 4 form communications link 550 using point-to-multipoint sector transceiver 560 of node 1 and point-to-multipoint remote 563 of node 4. This link 550 has 155 Mb/s of bandwidth or more bidirectionally. Similarly, the other ring links 551-553 are formed via each ring link's respective, adjacent ring nodes 1-4, thereby completing SONET ring 500.

The mux/switch 562 of each node 1-4 provides the circuit structure to transfer traffic from sector transceiver 560 to remote 563 and from remote 563 to sector transceiver 560 within each respective node 1-4, which in effect gives the nodes 1-4 the structure to transfer traffic between the nodes' 1-4 respective adjacent links 550-553. For example, the mux/switch 562 in node 1 permits the transfer of traffic from link 550 to link 551 and allows the transfer of traffic from link 551 to link 550. Sector transceiver 560 and remote 563 are designed to have at least enough radio bandwidth to support the requirements of the SONET ring 500, approximately 155 megabits/second in the present, non-limiting example. Mux/switch 562 also allows respective nodes 1-4 to transfer traffic to and from other networks or other co-located point-to-multipoint radio sectors.

Sector antennas 11 illuminates the area bounded by sector boundary 580, where the shaded area represents a point-to-multipoint frequency division multiplex downstream link 541. This area covers node 4, such that link 550 may be completed between node 1 and node 4. Also, the shaded area representing downstream link 541 also covers a plurality of further point-to-multipoint remotes (REM 1-3), REM 1-3 not being part of links 550-553 of ring 5.

The design of sector transceiver 560 of node 1 can be enhanced to achieve greater bandwidth, statically allocated, in excess of that required for link 550 from node 1 towards node 4 on SONET ring 500. This greater bandwidth is usable in downstream link 541 for access service to REM 1-3 within the downstream link 541 area. Therefore, link 550, in the direction from node 1 towards node 4, and downstream link 541 are both actually the same radio signal, i.e., a single frequency-division-multiplex channel transmitted from the sector transceiver of node 1 (560).

Part of the bandwidth of downstream link 541 is dedicated to link 550 and the remaining bandwidth of downstream link 541 is dedicated to access service to REM 1-3. Link 550 from node 1 towards node 4 is part of the bandwidth of point-to-multipoint downstream link 541 and link 550 from node 1 towards node 4 is drawn separately from downstream link 541 to illustrate pictorially the completion of link 550 from node 1 towards node 4 of ring 500. However, link 550 from node 4 towards node 1 is a point-to-multipoint upstream link to sector transceiver 560 of node 1, as is upstream link 540 from REM1 to sector transceiver 560.

In this example, 155 Mb/s is allocated bidirectionally to the SONET ring 500 and 45 Mb/s of further bandwidth is allocated to the point-to-multipoint access network's downstream link 541 to REM 1-3. The illustrated point-to-multipoint radios, e.g., sector transceiver 560, remote 563, and REM 1-3, each are designed for a total of 200 Mb/s or more bidirectional communication. REM 1-3 can communicate with an upstream channel 540 (each of REM 1-3 having its own upstream channel in this example). Sector transceiver 560 of node 1 can be enhanced to receive the further upstream links 540 from REM 1-3, including the ability to receive further traffic bandwidth and further upstream carriers, depending on the duplexing scheme used. The point-to-multipoint access user traffic on upstream links 540 and downstream link 541 can be switched and/or multiplexed onto/from ring link 550 by external mux/switch 562 or by an internal mux/switch as defined before.

The other ring links 551-553 are also implemented by point-to-multipoint networks, although, for clarity, the sector areas are not shaded in FIG. 5. The network formed by links 550-553 is formed herein as a consecutive-point-to-multipoint network. Although four nodes are illustrated for this network, any plurality of nodes in the consecutive point-to-multipoint network are possible in the present invention.

In the illustrated example, node 1 includes a sector transceiver 560 with sector antenna 511 transmitting counter-clockwise along link 550 and a remote 563 with high-gain antenna 523 transmitting clockwise along link 551. Each node 1-4 on ring 500 includes this arrangement, although the node design may be reversed in the present invention. It would also be possible to construct ring nodes with clockwise and counter-clockwise sector transceivers and alternate such nodes in the ring with nodes constructed with clockwise and counter-clockwise remotes. It would also be possible to construct the ring entirely of nodes with clockwise and counter-clockwise sector transceivers, with appropriate sector transceiver-to-sector transceiver duplexing choices, such as TDMA upstream and downstream.

In this special sector-to-sector communications scenario, a downstream link would refer to a signal that a sector transmits. When the receiving sector receives that signal, it would be referred to as an upstream link. The same terminology can be used in the reverse direction. It would also be possible to construct the ring such that some, but not all, links 550-553 are point-to-point links. Other various arrangements and combinations are also possible as suggested by those skilled in the art. Ring nodes 1-4 can also be implemented with one or more radios.

Other point-to-multipoint networks (or “sectors”) may be co-located with nodes 1-4, and provide enhanced geographical coverage. These other sectors could be connected to switch 562 and provide switching between all sectors at the node and from these sectors to ring 500. For example, if 90 degree sector antennas 511 are used, then four sectors could be used to provide 360 degree geographic coverage.

Further bandwidth is required for the point-to-multipoint access service and this bandwidth can be statically allocated for the downstream links and for the upstream links. Because some communications network applications, such as LAN traffic, are “bursty,” this type of burst traffic provides the opportunity to use momentary spare bandwidth capacity on downstream link 541 for communications to remotes REM 1-3, and from sector transceiver 560 of node 1 towards remote 563 of node 4 of link 550. In addition, the upstream link 540 bandwidth may be shared, as described below, among REM 1-3 and link 550 from remote 563 of node 4 towards sector transceiver 560 of node 1, in this example. This further bandwidth can also be allocated dynamically on links 551-553 and their respective nodes and remotes.

The consecutive point-to-multipoint network architecture stream in FIG. 6 provides several advantages over separate backbone and access technologies:

1) Although point-to-multipoint radios may be more expensive and complicated than point-to-point radios, the point-to-multipoint radio typically has greater cost efficiency because it provides two services rather than one: (a) the point-to-point ring service, and (b) the point-to-multipoint radio access service. Prior art techniques provide a point-to-point link (spur) to each access site from a backbone node. In the case of point-to-point radio access links, the number of radios for access equals twice the number of links. In the present invention, on the other hand, the number of radios is equal to the number of links plus one point-to-multipoint sector transceiver, which also serves as a backbone radio;

2) Fewer radios result in reduced need for rack space;

3) Additional revenue may be obtained via the access service, thereby providing earlier justification for the ring network or ring node;

4) The integrated access and backbone networks may enjoy improved management with a single management system, lower training costs and fewer inventory items; and

5) Radio bandwidth may be shared between the backbone network and the access network using bandwidth-on-demand.

The remote high-gain antennas 521 shown in FIG. 6 are typically parabolic antennas. The sector antennas 511 are typically waveguide antennas. Scanning or beam-shaping antennas provide the means to change the beam width and angles of the radio beam dynamically according to various schemes including: (a) statically determined scanning angles and dwell times; (b) traffic-load-related plans with dynamic bandwidth allocation; and (c) directing the beam according to addressing information in the user message units, for example.

Scanning or beam-shaping antennas (or “stearable” antennas) are especially well-suited for point-to-multipoint and consecutive point-to-multipoint applications, if used as a point-to-multipoint sector antenna. All the radio energy can be directed via a narrow beam to a point-to-multipoint remote (on the ring or at an access site) for a period, thus increasing the radio range compared to a waveguide antenna. The illustrated embodiments, however, are not limiting and the present invention can use scanning or beam-shaping antennas, including their use at the point-to-multipoint remote.

The OC-3 ring example shown in FIG. 6 is only one non-limiting example of the present invention, which can include the antenna types, duplex methods, modulation schemes, communication standards, data rates, protocols, message unit types, and backbone network topologies commonly used in the industry, such as shown in FIGS. 1-5. If a single-ring network transmits in only one direction around the ring, those ring links can use point-to-multipoint links and operate bidirectionally for access service or for network management functions.

In the example of FIG. 6, a single radio link 550, i.e., a single carrier, is used in each direction. Multiple carriers or beams, the sum which equals or exceeds the desired, composite ring link 550 bandwidth, however, may be used. Various multiplexing methods, well-known in the industry, may be used to divide the ring 500 traffic among the various carriers or beams. These multiplexing methods include time-division-multiplex (TDM), packet multiplexing and other multiplexing techniques known to those skilled in the art. Multiple-carrier ring links 550 can also be used in the present invention, including an application in the point-to-multipoint network of FIG. 5, for both upstream and downstream links, and other network topologies described herein. Access to the backbone network, such as a ring or to a backhaul, is not the only service provided by the point-to-multipoint network. For example, remote-to-remote service within the same sector via the mux/switch 562 is provided by the consecutive point-to-multipoint network. As explained below, remote-to-remote service between remotes within the same cellular network cell is supported by the point-to-multipoint network of the present invention.

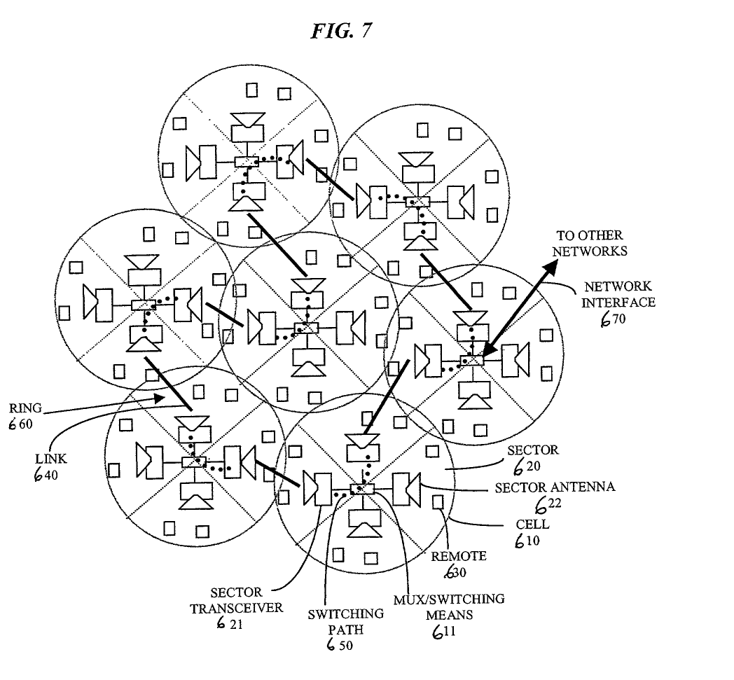

FIG. 7 illustrates a fixed cellular network that incorporates the consecutive point-to-multipoint network. As is known to those skilled in the art, two types of cellular networks are common in the industry: (1) mobile cellular and (2) fixed cellular. A mobile cellular network includes, as an example, cellular telephone networks. With fixed cellular networks, however, the users' network terminals are at a fixed location, such as an office building, small-office-home-office (SOHO) or residence, typically carrying business traffic or residential voice and Internet traffic.

Cellular networks include cells 610, each having adjacent point-to-multipoint sectors 620 of the type of described above. Typically, the size and shape of a cell 610 is determined by the maximum communications coverage area proceeding from the sector transceivers 521 using criteria common in the radio art, including the radio band, sector antenna 620 type, the weather profile of the area, the transmission capabilities of the equipment, and the required availability of the cell 610, which typically are placed adjacent to one another to give extended coverage to a region. The cells 610 have four sectors 620, although a greater number or fewer number of sectors per cell are possible. Lapses in coverage created by an omission of some sectors 620 from a cell 610 or complete omission of a cell 610 are permitted for various reasons, such as construction planning or lack of potential users in the area.

Usually, the sector transceivers 621 within a cell 610 are interconnected by a mux/switch 611, which permits sector-to-sector 620 communications. In this illustrated example, the mux/switch 611 interconnects the links 640 between the cells 610 at each end of the link 640, represented by switching path 650 (a heavy, dashed line in the figure) through mux/switch 611.

The ring links 640, the sector transceivers 621 supporting ring links 640, mux/switch 611, and the switching paths 650 through said mux/switch 611 form the ring backbone network generally indicated by ring 660, which is integrated with point-to-multipoint sectors 620, forming “access networks” for the point-to-multipoint remotes 630 to the ring network 660. Some of the sectors also serve as a portion of ring links 640. Other radio ring formation methods can be used in the present invention. For example, the ring could be formed by a sector transceiver 521 at one end of the ring link 540 and a point-to-multipoint remote 530 at the other end, as illustrated in FIG. 6.

In FIG. 7, the mux/switch 611 enables the consecutive point-to-multipoint network to communicate with other networks (not shown), as indicated by network interface 670 from a mux/switch 611 at one of the cells 610. These other networks could, for example, be ring networks, hierarchical networks, mesh networks, concatenated networks, star networks, grid networks, and other consecutive point-to-multipoint networks suggested by those skilled in the art.

Well-known examples of fixed cellular networks are LMDS (local multipoint distribution service) and MMDS (multichannel multipoint distribution service) networks. The former typically provides voice, data and/or video service to business customers. The latter typically provides voice, data and/or video service to small-office-home-office (SOHO) or residential customers. In both examples, the communications medium is microwave radio.

The consecutive point-to-multipoint network concepts of FIG. 6 and FIG. 7 can also be applied to a mesh network, in which a mesh backbone network is implemented via point-to-multipoint sector transceivers and remotes, providing access service via the sector transceivers to other point-to-multipoint remotes. Such a mesh backbone network would use networking protocols and procedures appropriate for mesh networks, such as IP routing, ATM switching, and other techniques suggested by those skilled in the art.

Consecutive point-to-multipoint networks could be used in other topologies, using appropriate, well-known network protocols and procedures, including hierarchical networks, concatenated networks, star networks, grid networks, and other network topologies. For example, the ring 660 network of FIG. 7 can be converted to a simple, partial mesh network, for example, by deleting any one of links 640 and using appropriate networking protocols and procedures for mesh networks.

The configuration shown in this non-limiting consecutive point-to-multipoint network example of FIG. 7 could use a greater number or fewer number of point-to-multipoint cells 610, and use the communication standards, data rates, protocols, and message unit types as described for ring networks and other networks topologies. Also, different duplexing methods, radio bands, modulation techniques, antenna types, and cell configurations (partial or full) can be used. The present invention can also use consecutive point-to-multipoint networks for providing backhaul links for mobile cellular networks, optionally providing data, video and/or voice access service to nearby business and/or residential customers. Access to the backbone network, such as a ring or to a backhaul, is not the only service provided by the fixed cellular network. For example, remote-to-remote service within the same cell (inter- and intra-sector) via mux/switch 611 can be provided by the fixed cellular network.

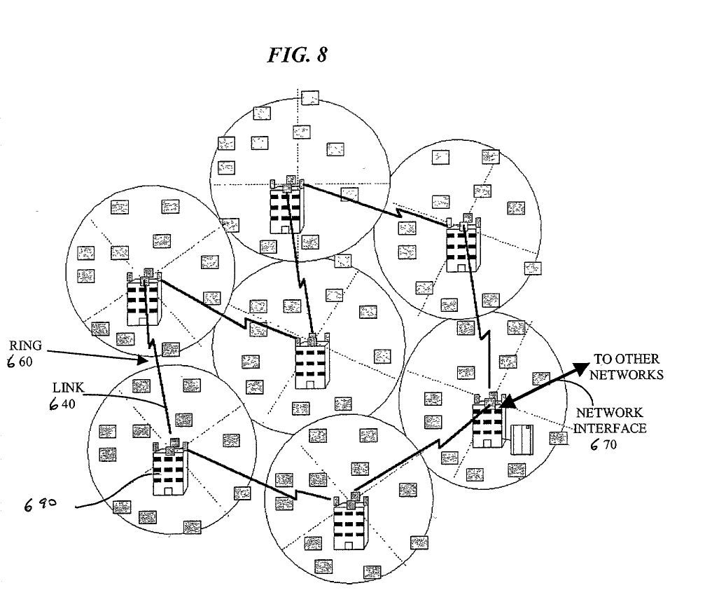

FIG. 8 illustrates a typical but non-limiting application of the consecutive point-to-multipoint network of FIG. 7, in which the equipment is used at high-rise buildings 690.

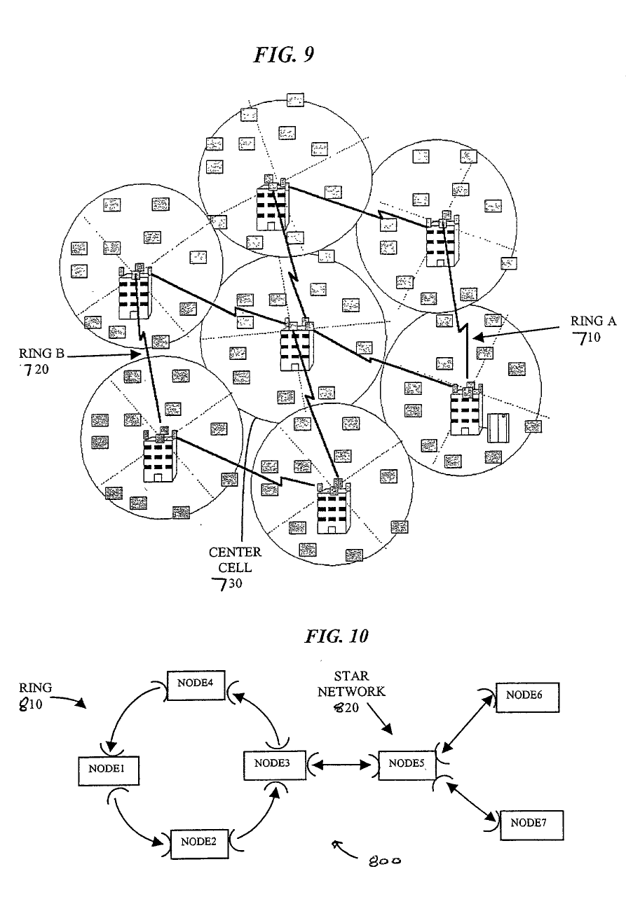

FIG. 9 is a non-limiting, example of a consecutive point-to-multipoint network, showing that the network is not limited to a single ring. In the present example, center cell 730 supports ring A 710 and ring B 720. These two rings may be interconnected by the mux/switch described in FIG. 7, or the two rings may be independent of each other, depending on the end-user requirements. Many different configurations are possible, including any combination of ring networks, mesh networks, concatenated networks, and other network topologies suggested by those skilled in the art.

FIG. 10 is an example of a “concatenated” network 800. It includes ring network 810 joined at a common node 3 with star network 820. Ring network 810 includes nodes 1-4. Star network 820 includes base node 5, common node 3, and nodes 6-7.

Other network types could be appended to common node 3, including hierarchical networks, other ring networks, and other concatenated networks, for example. Other networks could be appended to some or all of the nodes 1-4 of ring network 810, which could be replaced with any other network topology type. To each of these configurations of concatenated networks, other networks could be appended, producing ever-larger concatenated networks.

The backbone networks of consecutive point-to-multipoint networks as described herein are not limited to basic network topologies, but include the concatenation of other network nodes. Consecutive point-to-multipoint networks include irregular network topology that could be constructed from a concatenation of the basic network types and can be used as a backbone network constructed of point-to-multipoint sector transceivers and point-to-multipoint remotes using appropriate network protocols and procedures. The point-to-multipoint sector transceivers provide access to other point-to-multipoint remote nodes.

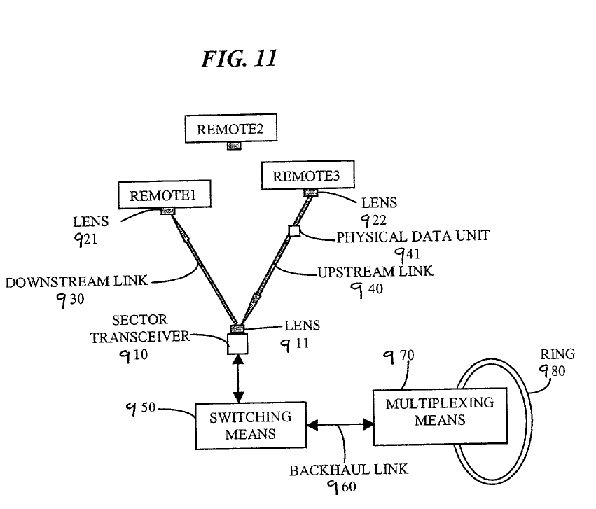

FIG. 11 illustrates a fiberless optical point-to-multipoint network, which is similar to the radio point-to-multipoint network as described before. All fiberless optical point-to-multipoint remotes 1-3 in this example communicate through sector transceiver 910. Remotes 1-3 do not communicate directly with any other of the remotes 1-3. Physical data units 941 from remote 3, for example, may only reach remote 1 or remote 2 if sector transceiver 910 has an internal switch or is connected to a switch 950. In the illustrated example, sector transceiver 910 is connected to switch 950 which is connected via backhaul link 960 to multiplexer 970, providing an interface to ring 980.

Alternatively, ring 980 could be connected directly to sector transceiver 910 if the switching and/or multiplexing functionality are included in the sector transceiver 910.

Switching and multiplexing are well-known in the data communications industry and all such arrangements of switching and multiplexing onto ring circuits and other backbone networks can be used by the present invention. ATM switches, frame relay switches, ethernet switches, IP switches, and IP routers are examples of switches 950 that can be used in the present invention. SONET and SDH add/drop multiplexers are examples of multiplexer 970 that can be used in the present invention. In this example, the point-to-multipoint network is presumed to be packet-based over the air and requires packet switching and add/drop multiplexing into and from tributaries of the illustrated synchronous ring 980.

A single, downstream link 930 extends from sector transceiver 910 to all remotes 1-3. In this example, downstream link 930 is a narrow, stearable optical beam (unlike the relatively wide frequency division multiplex radio downstream link described before), which covers all remotes 1-3 by hopping therebetween. Downstream link 930 is transmitted via a fiberless optical point-to-multipoint lens 911, which covers the area of interest (the sector) expressed in angular terms (such as 45 degree or 90 degree sector). The sector in the figure is the area over which the fiberless optical lens 911 of the transceiver 910 can scan. The figure represents a moment in time, according to the TDMA upstream/TDMA downstream duplex method used in this example, in which sector transceiver 910 is illuminating the downstream link 930 towards remote 1. Remote 3 illuminates upstream link 940 via fiberless optical lens 922 towards sector transceiver 910. At other moments in time, the other remotes 1-2 transmit upstream towards sector transceiver 910 and sector transceiver 910 will illuminate downstream towards the other remotes 2-3. TDMA is well-known in the radio art and may be used in fiberless optical applications. A single downstream fiberless optical beam is illustrated, but multiple downstream beams could be used as well. Each remote 1-3 would be illuminated only by one of the downstream beams 930 at a time.

Other point-to-multipoint networks (or sectors) may be co-located with the point-to-multipoint network of FIG. 11 to provide greater geographical coverage, and may be connected to switch 950 to provide switching between sectors, and from these other sectors to the backhaul link(s) 960 and thereby to ring 980. For example, if 90 degree sector scanning optical transceivers 911 are used, then four sectors could be used to provide 360 degree geographic coverage.

Different data communication standards, data rates, protocols, and message unit types as described for rings, mesh, and radio point-to-multipoint and other networks can be used for the illustrated fiberless optical point-to-multipoint networks. The consecutive point-to-multipoint network of FIG. 6 can be used as a building block for the consecutive point-to-multipoint fixed cellular network of FIG. 7. The network shown in FIG. 11 can also be used as a building block for the consecutive point-to-multipoint fixed cellular network of FIG. 7, which is generic with respect to fiberless optical- or radio-based point-to-multipoint networks.

Thus, the network of FIG. 7 can be used as a radio-based and a fiberless optical-based consecutive point-to-multipoint fixed cellular network, depending on whether the network shown in FIG. 6 was implemented from the structure shown in FIG. 5 or FIG. 11, respectively.

FIG. 8 is an example of a consecutive point-to-multipoint fixed cellular network based on the network structure of FIG. 7. Therefore, the network shown in FIG. 8 could be a radio-based or a fiberless optical-based consecutive point-to-multipoint fixed cellular network, depending on whether the structure shown in FIG. 6 was implemented from the structure shown in FIGS. 5 or 11. FIG. 9 is an example of a consecutive point-to-multipoint fixed cellular network with two rings based on the network of FIG. 7. Therefore, the network shown in FIG. 9 could be a radio-based or a fiberless optical-based consecutive point-to-multipoint fixed cellular network, depending on whether the structure shown in FIG. 6 was implemented from the structure shown in FIGS. 5 or 11.

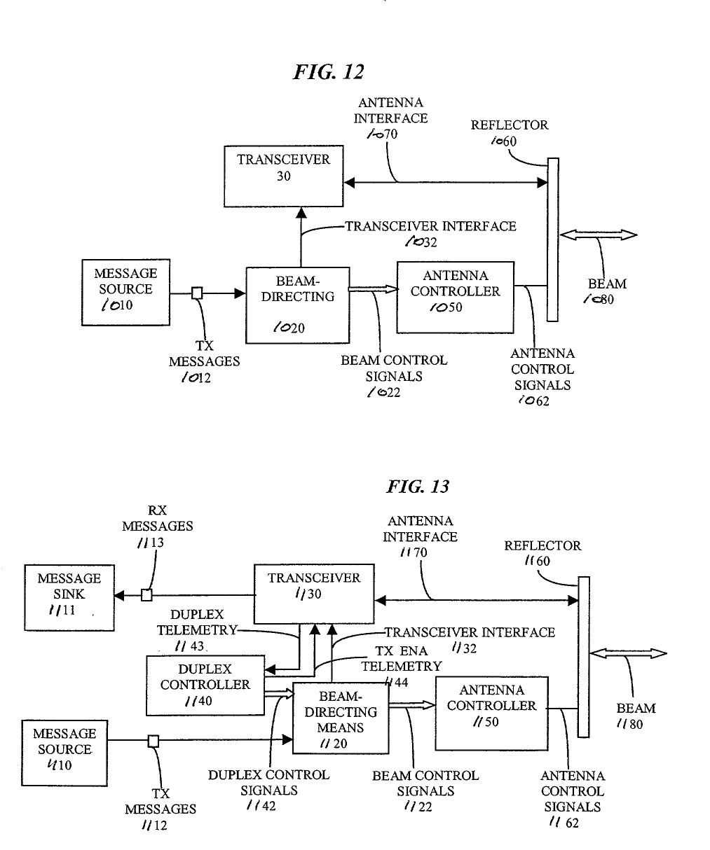

FIG. 12 illustrates an example of a routing-based scanning antenna, including a reflector 1060, an antenna controller 1050, a beam-directing circuit 1020, and a transceiver 1030. Users'transmit messages 1012 are supplied to beam directing circuit 1020 by message source 1010. Antenna controller 1050 exercises physical control of reflector 1006 using antenna control signals 1062 to adjust the beam angles, beam width and dwell time of a beam 1080 from reflector 1060. Beam-directing circuit 1020 uses beam control signals 1022 to direct antenna controller 1050 and adjust the beam angles, beam width and dwell time according to the real-time requirements of the arriving transmit messages 1012 from message source 1010. The angles are specified via the beam-control signals 1022, typically in terms of, but not limited to azimuth and elevation angles, or via polar coordinates, using pointing techniques well-known to those skilled in the radio and antenna arts. Depending on the design of the reflector 1060, one of the angles may be fixed so that there is no degree of freedom for that specification. For example, the elevation may be fixed statically by an installation procedure and only the azimuth may be controlled by the antenna controller 1050.

Beam-directing circuit 1020 determines the beam-control signals 1022 by observing an address field of the incoming user transmit messages 1012 from message source 1010 and determining from the address field the destination (not shown) of the transmit message 1012. Determining the destination from the address field is a “routing” function and therefore this circuit structure of present invention could be referred to as a “routing antenna.”

Beam-directing circuit 1020 also observes the size of the transmit message 1012 to determine the dwell time required to transmit the message (or the message size may be fixed, as in the example of ATM cells, which are of a fixed length). Beam-directing circuit 1020 adjusts beam-control signals 1022 for the dwell time and destination, and timely passes transmit message 1012 along transceiver interface 1032 to transceiver 1030, such that transceiver 1030 may timely transmit a message at the moment when the beam 1080 is directed to a destination. This destination can be determined from the address field of transmit messages 1012 in many ways, such as storing in a table the beam angles of a destination (a remote site) determined through the installation and antenna pointing procedures for the remote site.

Transmit message 1012 can be of any of the standard protocols well-known in the industry, such as ATM, IP, ethernet, frame relay, SNA, X.25, and others. Custom protocols with address fields could also be used.

The description relative to the example shown in FIG. 12 is directed to the transmission of transmit messages 1012 using a single beam. It does not describe the reception of message units by the scanning antenna. The scanning antenna could be designed for multiple, transmission beams, and the beam-directing circuit 1020 and antenna controller 1050 manage these additional beams. The beam-directing circuit 1020 can use various techniques, such as having a queue per transmission beam, and a load-leveling algorithm to distribute the message units to the multiple beams' queue.

A second reception beam circuit may be used to receive message units from over the air, such that reception is independent of transmission. The reception beam circuit could, for example, use a round-robin scanning method (a “schedule”) based on the remote sites found in the table.

The transmit messages 1012 are passively observed by beam-directing circuit 1020 on their way to transceiver 1030. In this configuration, the messages are not stored or queued, but are sent synchronously to transceiver 1030 in a manner such that beam-directing circuit 1020 sees the addresses therein and otherwise operates as described above.

The transceiver 1030 can be removed allowing transceiver interface 1032 and antenna interface 1070 to be external interfaces, and thus, operable with an external transceiver 1030.

FIG. 13 shows a routing-based scanning antenna that includes a reflector 1160, an antenna controller 1150, a beam-directing circuit 1120, a transceiver 1130, and a duplex controller 1140.

User transmit messages 1112 are supplied to beam-directing circuit 1120 by message source 1110. User receive messages 1113 are received from a remote site (not shown) and sent to message sink 1111. Antenna controller 1150 exercises physical control of reflector 1160 using antenna control signals 1162 to adjust the beam angles, beam width and dwell time of a beam 1180 proceeding from reflector 1160. Beam-directing circuit 1120 uses beam control signals 1122 to direct antenna controller 1150 to adjust the beam angles, beam width and dwell time according to the real-time requirements of the arriving transmit messages 1112 from message source 1110. The angles are specified via the beam-control signals 1122, typically in terms of, but not limited to, azimuth and elevation angles, or via polar coordinates, using pointing methods well-known to those skilled in the art. Depending on the design of reflector 1160, one of the pointing specifications may be fixed such that there is no degree of freedom for that specification. For example, the elevation may be fixed statically by an installation procedure and only the azimuth may be controlled by the antenna controller 1150.

Beam-directing circuit 1120 determines the beam-control signals 1122 by observing an address field of incoming transmit messages 1112 from message source 1110 and determining from the address field the destination of a remote site (not shown) of transmit message 1112. Determining the destination from the address field is a “routing” function and operable as a “routing antenna.” Beam-directing circuit 1120 also observes the size of the transmit message 1112 to determine the dwell time required to transmit a message (or the message size may be fixed, as in the example of ATM cells, which are of a fixed length). Beam-directing circuit 1120 adjusts beam-control signals 1122 for the dwell time and the destination, and timely passes the transmit messages 1112 along transceiver interface 1132 to transceiver 1130 such that transceiver 1130 may timely transmit transmit messages 1112 at the moment when said beam 1180 is directed to the destination for the dwell time. The destination can be determined from the address field of transmit messages 1112 in many ways, such as storing in a table available to beam-directing circuit 1120 the beam angles of a remote site (a destination) determined through the installation and pointing procedures for the remote site.

In addition, beam-directing circuit 1120 receives duplex control signals 1142 from duplex controller 1140. Duplex control signals 1142 inform beam-directing circuit 1120 of a set of destinations (remote sites) and dwell times. Beam-directing circuit 1120 calculates a set of beam control signals 1122 from the set of destinations and dwell times that will enable antenna controller 1150 to specify a set of antenna control signals 1162 that will direct reflector 1160 to receive timely a beam from the positions for the dwell times, thereby enabling transceiver 1130 to timely receive messages 1113 via reflector 1160 and transfer the receive messages 1113 to message sink 1111.

Beam-directing circuit 1120 also sends transmit telemetry 1144 (a “schedule”) to the remotes via transceiver 1130, and transmit telemetry 1144 informing the remotes of a set of times and dwell times such that the remotes may timely transmit the receive messages 1113 so that receive messages 1113 may be timely received at reflector 1160. Duplex controller 1140 determines the set of duplex control signals based on a fixed scanning pattern derived from the table. Alternatively, duplex controller 1140 determines the set of duplex control signals based on duplex telemetry 1143 received via transceiver 1130. This telemetry is received over antenna interface 1170 by reflector 1160 ago from remote sites (not shown). The telemetry requests a certain amount of bandwidth based on the remote site's dynamic message load, allowing bandwidth-on-demand.

The transmit message 1112 and receive message 1113 can be of any of the standard protocols well-known in the industry, such as ATM, IP, ethernet, frame relay, SNA, X.25. Custom protocols with address fields could be used as well.

The present invention could also include a configuration where the transmit messages 1112 are passively observed by beam-directing circuit 1120 to transceiver 1130. In this configuration, the messages are not stored or queued, but are sent synchronously to transceiver 1130 in a manner such that beam-directing circuit 1120 may see the addresses therein and otherwise operate as described above.

The transceiver 1130 can be external, allowing transceiver interface 1132, antenna interface 1170, and the interface for duplex telemetry 1143 external interfaces.

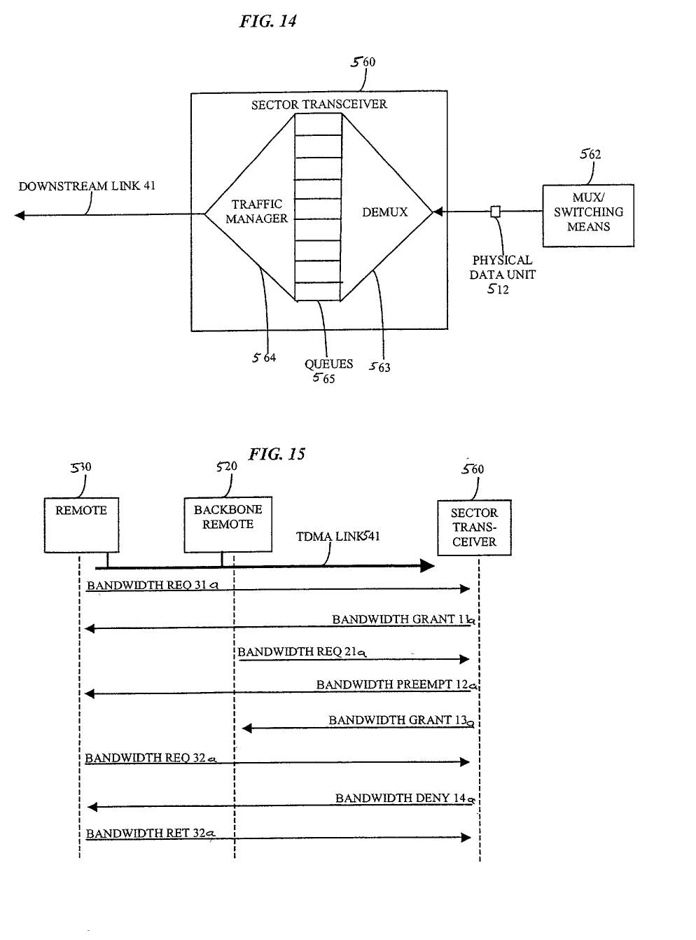

FIG. 14 illustrates a bandwidth-on-demand process for the downstream link 541, sector transceiver 560 and mux/switch 562 of FIG. 6. Referring to FIG. 14, the bandwidth on demand process for downstream link 541 is a traffic management process rather than a true dynamic allocation process because sector transceiver 560 is the only device transmitting in the downstream direction. The term traffic management is well-known in the data communications industry and is described in detail in the ATM Forum's Traffic Management 4.1 specification, which is hereby incorporated by reference. An implementation of traffic management is described in the Infineon ABM data sheet, which is hereby incorporated by reference, mux/switch 562 sends physical data units 512 destined for downstream link 541 to demultiplexer 563, which sorts these physical data units 512, by the physical data unit 512 address found therein, into queues 565 dedicated to the remote sites (remote 563 and REM 1-3 sites of FIG. 6).

The queues 565 have assigned priority relative to one another according to the network operator's chosen configuration. The queues 565 are serviced in priority order by traffic manager 564 so that the downstream link 541 bandwidth is distributed (scheduled) according to priority. By this method, priority may be assigned to the backbone network and access network which share downstream link 541. While the concepts of traffic management are well-understood and would normally be applied to the traffic to remote point-to-multipoint sites (REM 1-3) of FIG. 6, the bandwidth of a backbone network link (such as link 550 from node 1 towards node 4 of FIG. 6) could be managed together with point-to-multipoint sites, thereby creating a novel type of bandwidth-on-demand that shares bandwidth between a backbone network and an access network.

FIG. 15 illustrates the process for bandwidth-on-demand for the upstream link of a consecutive point-to-multipoint backbone link and the associated point-to-multipoint access network, as illustrated in FIG. 6. Unlike FIG. 6, the upstream links, including link 550 from node 4 towards node 1, must be replaced with one or more upstream links that use a time-based (shared) duplex method, such as time division multiple access (TDMA) for the preferred embodiment. This duplex method is well-known in the data communications industry. Time division multiple access divides a communications channel into time slots, which are statically or dynamically distributed among a community of sites sharing the link. The community of users share the link by using burst mode transmission in their assigned time slots. For the present example of FIG. 15, remote 530 and backbone remote 520 (corresponding to REM 1-3 and link 550 from node 4 towards node 1 of FIG. 6) would share a single time division multiple access TDMA link 541.

One method to measure traffic load on a shared link such as TDMA link 541 is to use queues for storing physical data units 512 until transmitted, and to use trend analysis of queue depths to determine if the queued physical data units 512 will require more than, equal to, or less than the bandwidth provided by the current assignment of timeslots on upstream link 540 over a certain period. If more bandwidth is required by remote 530, for example, at a moment in time than is provided by its present assignment of upstream link 540 time slots, remote 530 sends bandwidth req 31a to sector transceiver 560 to request the amount of bandwidth needed. Sector transceiver 560 integrates over a period of time all bandwidth reqs 31a for all sites sharing upstream link 540 and sends a bandwidth grant 11a to remote 530 if the queue analysis indicates that the bandwidth requested may be allocated. Bandwidth req 31a informs remote 530 of which time division multiple access time slots (a “schedule”) are granted. Otherwise, sector transceiver 560 may send bandwidth deny 14a if the bandwidth is not available.

Similarly, backbone remote 520 may send a bandwidth req 21a to request additional bandwidth. If the bandwidth is available, sector transceiver 560 will send bandwidth grant 13a. Otherwise, the transceiver can first take the required bandwidth away from remote 530 by sending bandwidth preempt 12a to remote 530 and then sending bandwidth grant 13a to backbone remote 520. At some time, remote 530 determines through continued queue depth trend analysis that its dynamically allocated bandwidth is no longer required in all or in part. Remote 530 may return that unneeded dynamically allocated bandwidth to upstream link 540 by sending bandwidth ret 32a to sector transceiver 560. Either the ring or the access network may be given priority, but in the example given, backbone remote 520 had priority.

Bandwidth req 31a, 21a, and 32a, bandwidth grant 11a and 13a, bandwidth preempt 12a, and bandwidth deny 14a are telemetry messages for bandwidth on demand. This set of messages is intended to illustrate bandwidth on demand and is not intended to be limiting. For example, additional telemetry messages may be added to for telemetry reliability, such as ARQ (automatic repeat request) protocol telemetry messages. The non-limiting example is representative of the types of scenarios comprehended by the present invention.

The present invention advantageously allows the sharing of bandwidth between a backbone network and an access network (via bandwidth on demand methods). The Infineon 4330 ATM Buffer Manager chip data book hereby incorporated by reference explains examples of the queuing and bandwidth allocation methods that can be used for the present invention. The IEEE 802.16.1/D1-2000 standard document hereby incorporated by reference, provides for a detailed, standardized mechanism for bandwidth-on-demand.

It is also possible to add initialization, power-up and reliability messages, such as ARQ (automatic repeat request) to the bandwidth-on-demand messages of FIG. 15. Additionally point-to-point links could be added to the backbone networks of the embodiments shown in FIGS. 5-10, for those sections of backbone networks not requiring point-to-point access.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A communications system comprising:
a plurality of network nodes and communications links that link said network nodes to form a high bandwidth backbone network, wherein at least one of said communications links forms a point-to-multipoint communications link between two network nodes;
at least one of said network nodes having a point-to-multipoint remote device at one end of the point-to-multipoint communications link;
at least one of said network nodes having a point-to-multipoint sector transceiver at the other end of the point-to-multipoint communications link for transmitting data in a sectored point-to-multipoint downstream communications link with remote devices including the linked point-to-multipoint remote device at the network node and receiving data from the point-to-multipoint remote device at the network node in a point-to-multipoint upstream communications link.

2. The communications system according to claim 1, wherein the backbone network comprises a single-ring network, a double-ring network, a full mesh network, a partial mesh network, a hierarchical network, a grid network or a concatenated network.

3. The communications system according to claim 1, wherein said node having said point-to-multipoint sector transceiver comprises a plurality of sector transceivers each operative for covering a respective geographic area.

4. The communications system according to claim 1, wherein said point-to-multipoint sector transceiver comprises a radio transceiver having a sector antenna for wirelessly communicating with remote devices.

5. The communications system according to claim 4, wherein said sector antenna comprises a waveguide antenna, a horn antenna, a smart antenna, a scanning antenna, or a beam-shaping antenna.

6. The communications system according to claim 1, wherein a remote device comprises a radio transceiver and a radio antenna.

7. The communications system according to claim 6, wherein said radio antenna comprises a parabolic antenna, a cassegrain antenna, a smart antenna, a scanning antenna, a beam-shaping antenna or a waveguide sector antenna.

8. The communications system according to claim 1, wherein communications links comprise optical communications links.

9. A communications system comprising:
a plurality of network nodes and communications links that link network nodes to form a high bandwidth backbone network, wherein at least one of said communications links forms a point-to-multipoint communications link between two network nodes;
at least one of said network nodes having a point-to-multipoint remote device at one end of the point-to-multipoint communications link;
at least one of said nodes having a point-to-multipoint sector transceiver at the other end of the point-to-multipoint communications link for transmitting data in a sectored point-to-multipoint downstream communications link with the linked point-to-multipoint remote device at the network node and receiving data from the point-to-multipoint remote device in a point-to-multipoint upstream communications link; and
a plurality of point-to-multipoint remote devices positioned within a coverage area provided by the point-to-multipoint sector transceiver for receiving data from said point-to-multipoint sector transceiver through the sectored point-to-multipoint downstream communications link and transmitting data to the point-to-multipoint sector transceiver in a point-to-multipoint upstream communications link.

10. The communications system according to claim 9, wherein said node having said point-to-multipoint sector transceiver further comprises a multiplexer/switch circuit for switching data between the backbone network and the plurality of point-to-multipoint remote devices.

11. The communications system according to claim 9, wherein said point-to-multipoint sector transceiver and plurality of point-to-multipoint remote devices forms an access network for the backbone network.

12. The communications system according to claim 9, wherein the backbone network comprises a single-ring network, a double-ring network, a full mesh network, a partial mesh network, a hierarchical network, a grid network or a concatenated network.

13. The communications system according to claim 9, wherein said node having said point-to-multipoint sector transceiver comprises a plurality of sector transceivers each operative for covering a respective area.

14. The communications system according to claim 9, wherein said point-to-multipoint sector transceiver comprises a radio transceiver having a sector antenna for communicating with remote devices.

15. The communications system according to claim 14, wherein said sector antenna comprises a waveguide antenna, a horn antenna, a smart antenna, a scanning antenna, or a beam-shaping antenna.

16. The communications system according to claim 9, wherein a remote device comprises a radio transceiver and a radio antenna.

17. The communications system according to claim 16, wherein said radio antenna comprises a parabolic antenna, a cassegrain antenna, a smart antenna, a scanning antenna, a beam-shaping antenna or a waveguide sector antenna.

18. The communications system according to claim 9, wherein communications links comprise optical communications links.

19. A communications system comprising:
a plurality of network nodes and communications links that link network nodes to form a high bandwidth backbone network, wherein at least one of said communications links forms a point-to-multipoint communications link between two network nodes;
at least one of said network nodes comprising a point-to-multipoint remote device at one end of the point-to-multipoint communications link;
at least one of said nodes comprising a point-to-multipoint wireless sector transceiver at the other end of the point-to-multipoint communications link for transmitting data in a sectored point-to-multipoint downstream communications link with the linked point-to-multipoint remote device at the network node and receiving data from the point-to-multipoint remote device in a point-to-multipoint upstream communications link;
a plurality of point-to-multipoint remote devices positioned within a coverage area provided by the point-to-multipoint sector transceiver for receiving data from said point-to-multipoint sector transceiver through the sectored point-to-multipoint downstream communications link and transmitting data to the point-to-multipoint sector transceiver in a point-to-multipoint upstream communications link; and
wherein said point-to-multipoint wireless sector transceiver includes a scanning antenna comprising a beam directing circuit and beam controller circuit for controlling the beam angle and dwell time of the scanning antenna and a message unit interface operatively connected to said beam directing circuit and/or beam controller circuit wherein the beam angle and dwell time for the scanning antenna are based on addressing information within the message data.

20. A communications system according to claim 19, and further comprising a duplex communications controller operatively connected to said beam directing circuit for determining when said scanning antenna may transmit and receive data.

21. A communications system according to claim 20, wherein said duplex communications controller comprises a time division multiple access controller.

22. A communications system according to claim 20, wherein said duplex communications controller comprises a time division multiple access controller.

23. The communications system according to claim 19, wherein said node having said point-to-multipoint sector transceiver further comprises a multiplexer/switch circuit for switching the transfer of data between the backbone network and the plurality of point-to-multipoint remote devices.

24. The communications system according to claim 19, wherein said point-to-multipoint sector transceiver and plurality of point-to-multipoint remote devices forms an access network for the backbone network.

25. The communications system according to claim 19, wherein the backbone network comprises a single-ring network, a double-ring network, a full mesh network, a partial mesh network, a hierarchical network, a grid network or a concatenated network.

26. The communications system according to claim 19, wherein said node having said point-to-multipoint sector transceiver comprises a plurality of sector transceivers each operative for covering a respective geographic area.

27. The communications system according to claim 19, wherein a remote device comprises a radio transceiver and a radio antenna.

28. The communications system according to claim 27, wherein said radio antenna comprises a parabolic antenna, a cassegrain antenna, a smart antenna, a scanning antenna, a beam-shaping antenna or a waveguide sector antenna.

29. The communications system according to claim 19, wherein communications links comprise optical communications links.

30. A scanning antenna comprising:
a beam shaping antenna;
a beam directing controller operatively connected to said beam shaping antenna for controlling said beam shaping antenna;
a beam directing circuit operatively connected to said beam directing controller;
a message interface unit operatively connected to said beam directing circuit and beam shaping antenna for transmitting message data from said beam shaping antenna, wherein the beam angle and dwell time for the beam shaping antenna are responsive to address information within the message data.

31. A scanning antenna according to claim 30, and further comprising a duplex communications controller operatively connected to said beam directing circuit for determining when said scanning antenna may transmit and receive data.

32. A scanning antenna according to claim 30, wherein said duplex communications controller comprises a time division multiple access controller.

33. A scanning antenna according to claim 30, wherein said duplex communications controller comprises a time division multiple access controller.
